(19) United States
(12) Patent Application Publication
(10) Pub. No.: US 2021/0095154 A1
(43) Pub. Date: Apr. 1, 2021

(54) WATER-BASED PIGMENT DISPERSION AND METHOD FOR PRODUCING WATER-BASED PIGMENT DISPERSION

(71) Applicant: DIC Corporation, Tokyo (JP)

(72) Inventors: Yoshitaka Tanaka, Kita-adachi-gun (JP); Yutaro Ueda, Kita-adachi-gun (JP); Yoshihiro Sato, Kita-adachi-gun (JP)

(73) Assignee: DIC Corporation, Tokyo (JP)

(21) Appl. No.: 17/027,998

(22) Filed: Sep. 22, 2020

(30) Foreign Application Priority Data
Sep. 27, 2019 (JP) 2019-177080

(51) Int. Cl. C09D 17/00; C09D 11/037; C09D 11/033; C09D 11/322

(52) U.S. Cl. CPC C09D 17/003; C09D 17/001; C09D 11/322; C09D 11/033; C09D 11/037

(57) ABSTRACT

A water-based pigment dispersion contains a pigment (A) including C.I. Pigment Orange 64 (a) having a primary particle size of 150 nm or less, a pigment-dispersing resin (B) containing a radical polymer having an acid value of 50 to 200 mg KOH/g, and water (C).

### BACKGROUND OF THE INVENTION

### 1. Field of the Invention

The present invention relates to a water-based pigment dispersion which contains C.I. Pigment Orange 64, and a method for producing the same.

### 2. Description of the Related Art

Inks containing a pigment are widely used in the case where printing is performed, for example, by offset printing, gravure printing, flexographic printing, silk-screen printing, or inkjet printing.

In particular, water-based pigment inks, in which water is used as a solvent, have low risk of flammability or the like compared with existing organic solvent-based inks, and therefore, various uses thereof have been studied.

A water-based pigment dispersion which contains a pigment, a pigment-dispersing resin, and an aqueous medium is known as the water-based pigment dispersion used for producing the water-based pigment ink. The water-based pigment dispersion is required to have a property of being capable of maintaining the state where the pigment is stably dispersed in the aqueous medium by the pigment-dispersing resin.

However, since ease of dispersion of the pigment contained in the water-based pigment dispersion in the aqueous medium varies depending on the type of pigment, the composition, and the like, in order to improve the dispersion stability of the water-based pigment dispersion, it is necessary to take measures depending on the type of pigment, the composition of ink, and the like.

On the other hand, in the case where printing is performed by inkjet printing using water-based pigment inks, in addition to inks of yellow, magenta, cyan, and black which are process colors, inks of green, red, blue, orange, and the like which are spot colors may be combined for use.

As a water-based ink using a pigment of the orange, for example, an ink containing C.I. Pigment Orange 64 is known (e.g., refer to International Publication Pamphlet No. 1999/05230).

However, in the ink, because of a large volume average particle size and the presence of coarse particles, in some cases, it is not possible to achieve dispersion stability at a level comparable to that of a process color ink or pigment dispersion and storage stability at a level capable of suppressing a change in physical properties with time.

Furthermore, as described above, the dispersion stability and storage stability of the water-based pigment dispersion depend on interaction between the type of pigment and the dispersing resin in many cases. Accordingly, even in the case where a pigment-dispersing resin used in a pigment dispersion of a process color is used in combination with a pigment for the spot color, it is not always possible to exhibit good dispersion stability. Therefore, in order to improve the dispersion stability of a water-based pigment dispersion for spot color, considerable trial and effort by one skilled in the art may be required in some cases.

### SUMMARY OF THE INVENTION

It is an object of the present invention to provide a water-based pigment dispersion which can be used to produce an ink having a reduced number of coarse particles, excellent dispersion stability, and excellent storage stability at a level unlikely to cause a change in physical properties with time.

According to an aspect of the present invention, a water-based pigment dispersion contains a pigment (A) including C.I. Pigment Orange 64 (a) having a primary particle size of 150 nm or less, a pigment-dispersing resin (B) containing a radical polymer having an acid value of 50 to 200 mg KOH/g, and water (C).

A water-based pigment dispersion and an ink containing the same according to the present invention have dispersion stability at a level comparable to that of a process color ink or water-based pigment dispersion.

### DESCRIPTION OF THE PREFERRED EMBODIMENTS

A water-based pigment dispersion according to the present invention contains a pigment (A) including C.I. Pigment Orange 64 (a) having a primary particle size of 150 nm or less, a pigment-dispersing resin (B) containing a radical polymer having an acid value of 50 to 200 mg KOH/g, and water (C). The term “water-based pigment dispersion” refers to a mixture in a state where a pigment is dispersed in a solvent such as water. The water-based pigment dispersion refers to a material which is used to produce a water-based pigment ink or a water-based pigment ink itself.

In the present invention, a pigment (A) including C.I. Pigment Orange 64 (a) is used.

As the C.I. Pigment Orange 64, C.I. Pigment Orange 64 having a primary particle size of 150 nm or less is used. Thus, it is possible to achieve storage stability at a level comparable to that of a process color ink or water-based pigment dispersion and storage stability at a level capable of suppressing a change in physical properties with time. Furthermore, C.I. Pigment Orange 64 having a primary particle size of preferably 50 to 130 nm, and more preferably 70 to 90 nm is used from the viewpoint of further improvement of storage stability. Note that the primary particle size values were measured by the following device under the following conditions.

First, a mixture of 1 part by mass of a pigment (A) including the C.I. Pigment Orange 64 (a) and 99 parts by mass of ethanol was placed dropwise on a mesh coated with collodion film, followed by drying, to obtain a measurement sample.

Next, 1,000 random particles of the measurement sample were observed using a scanning transmission electron microscope (STEM, JSM-7500FA, manufactured by JEOL Ltd., acceleration voltage: 30 kv), and the average value thereof was determined as the primary particle size.

The C.I. Pigment Orange 64 (a) having a primary particle size of 150 nm or less can be produced by subjecting C.I. Pigment Orange 64 having a primary particle size of more than 150 nm, for example, to dry pulverization treatment, wet pulverization treatment, solvent salt milling treatment, or the like. However, in the case where dry pulverization treatment or wet pulverization treatment is performed, since metal beads are used, there is a high possibility that a metal as an impurity will be mixed into the water-based pigment dispersion. Therefore, when the C.I. Pigment Orange 64 having a primary particle size of more than 150 nm is treated, it is preferable to employ a solvent salt milling treatment method in which there is a low possibility of mixing of a metal.

The solvent salt milling treatment is a method in which a mixture containing at least a coarse pigment, an inorganic salt, and an organic solvent is kneaded and ground using a mixing machine, such as a kneader, a twin roll mill, a triple roll mill, or an attritor. Note that, in the present invention, C.I. Pigment Orange 64 having a primary particle size of more than 150 nm is used as the coarse pigment.

As the inorganic salt that can be used in the solvent salt milling, preferably, a water-soluble inorganic salt is used, and for example, preferably, sodium chloride, potassium chloride, sodium sulfate, or the like is used. As the inorganic salt, more preferably, an inorganic salt having a primary particle size of 0.5 to 50 μm is used. The inorganic salt is used in an amount of preferably 3 to 20 parts by mass, and more preferably 5 to 15 parts by mass, relative to 1 part by mass of the coarse pigment.

As the organic solvent that can be used in the solvent salt milling, preferably, an organic solvent capable of suppressing crystal growth is used. As such an organic solvent, a water-soluble organic solvent can be suitably used. For example, diethylene glycol, glycerin, ethylene glycol, propylene glycol, liquid polyethylene glycol, liquid polypropylene glycol, 2-(methoxymethoxy)ethanol, 2-butoxyethanol, 2-(isopentyloxy)ethanol, 2-(hexyloxy)ethanol, diethylene glycol monomethyl ether, diethylene glycol monoethyl ether, diethylene glycol monobutyl ether, triethylene glycol, triethylene glycol monomethyl ether, 1-methoxy-2-propanol, 1-ethoxy-2-propanol, dipropylene glycol, dipropylene glycol monomethyl ether, dipropylene glycol monomethyl ether, dipropylene glycol, and the like can be used.

The amount of the organic solvent is preferably 0.01 to 5 parts by mass relative to 1 part by mass of the coarse pigment.

The temperature at which kneading and grinding are performed in the solvent salt milling is preferably 30 to 150° C. The time for kneading and grinding is preferably 2 to 20 hours.

By the method described above, it is possible to obtain a mixture of C.I. Pigment Orange 64 (a) having a primary particle size of 150 nm or less, the inorganic salt, and the organic solvent. When producing a water-based pigment dispersion or an ink according to the present invention by using the mixture, according to need, washing and filtering may be performed to remove the inorganic salt and the organic solvent, followed by drying and pulverization before use.

In the washing and filtering step, either water washing or hot water washing can be employed. Furthermore, washing may be performed using an acid, alkali, or solvent so as not to change the crystal state of the C.I. Pigment Orange 64 (a). The washing may be repeated one to five times. In the case where a water-soluble inorganic salt and a water-soluble organic solvent are used as the inorganic salt and the organic solvent, the water-soluble inorganic salt and the water-soluble organic solvent can be easily removed by the washing.

In the drying step, a batch-type or continuous drying method can be performed, in which water and/or solvent is removed from the pigment, for example, by heating at 80 to 120° C. using a heat source installed in a dryer. As the dryer, a box dryer, a band dryer, a spray dryer, or the like can be used.

The pulverizing step is not a step for increasing the specific surface area of the C.I. Pigment Orange 64 (a) or further decreasing the primary particle size, but is a step which may be performed for disintegrating lumps of the C.I. Pigment Orange 64 (a) formed in the drying step when a box dryer or band dryer has been used.

In the pulverizing step, for example, a mortar, a juicer, a hammer mill, a disk mill, a pin mill, a jet mill, or the like can be used.

The C.I. Pigment Orange 64 (a) having a primary particle size of 150 nm or less obtained by performing the solvent salt milling treatment is preferably used in an amount in a range of 70 to 100% by mass relative to the total pigment (A) from the viewpoint of obtaining a water-based pigment dispersion having excellent storage stability, more preferably used in an amount in a range of 80 to 100% by mass, still more preferably used in an amount in a range of 90 to 100% by mass, and particularly preferably used in an amount in a range of 99 to 100% by mass.

As the pigment-dispersing resin (B), a radical polymer having an acid value of 50 to 200 mg KOH/g is used. By using a radical polymer having an acid value in the above range as the pigment-dispersing resin (B), it is possible to obtain a water-based pigment dispersion or ink for inkjet recording provided with good dispersion stability. The acid value of the dispersing resin (B) is preferably in a range of 90 to 150 mg KOH/g, and particularly preferably in a range of 110 to 130 mg KOH/g from the viewpoint of obtaining a water-based pigment dispersion or ink for inkjet recording having better dispersion stability. Note that the acid value refers to a value measured in accordance with JIS “K0070: 1992, test methods for acid value, saponification value, ester value, iodine value, hydroxyl value and unsaponifiable matter of chemical products”.

As the radical polymer, a radical polymer having an aromatic cyclic structure or heterocyclic structure can be used. More preferably, a radical polymer having a benzene ring structure is used, and still more preferably, a radical polymer having a structure derived from styrene is used.

The mass ratio of the structural unit derived from styrene to the total amount of the radical polymer is preferably 50% by mass or more, and more preferably in a range of 60 to 95% by mass from the viewpoint of obtaining a water-based pigment dispersion having better dispersion stability.

As the radical polymer, a polymer obtained by radical polymerization of various monomers can be used.

As for the monomer, in the case where an aromatic cyclic structure is introduced into the radical polymer, a monomer having an aromatic cyclic structure can be used, and in the case where a heterocyclic structure is introduced, a monomer having a heterocyclic structure can be used.

As the monomer having an aromatic cyclic structure, for example, styrene, p-tert-butyl dimethyl siloxystyrene, o-methyl styrene, p-methyl styrene, p-tert-butyl styrene, p-tert-butoxystyrene, m-tert-butoxystyrene, p-tert-(1-ethoxymethyl)styrene, m-chlorostyrene, p-chlorostyrene, p-fluorostyrene, α-methyl styrene, p-methyl-α-methyl styrene, vinyl naphthalene, and vinyl anthracene can be used.

As the monomer having a heterocyclic structure, for example, vinylpyridine monomers, such as 2-vinylpyridine and 4-vinylpyridine, can be used.

In the case where a radical polymer having both an aromatic cyclic structure and a heterocyclic structure is used as the radical polymer, a monomer having an aromatic cyclic structure and a monomer having a heterocyclic structure can be used in combination as the monomer.

As the radical polymer, as described above, a radical polymer having a structural unit derived from styrene is preferably used. Therefore, as the monomer, styrene, α-methyl styrene, or p-tert-butyl styrene is more preferably used.

As the monomer that can be used for producing the radical polymer, in addition to the monomers described above, other monomers can be used according to need.

Examples of the other monomers include methyl (meth)acrylate, n-propyl (meth)acrylate, isopropyl (meth)acrylate, n-butyl (meth)acrylate, sec-butyl (meth)acrylate, tert-butyl (meth)acrylate, 2-ethylbutyl (meth)acrylate, 1,3-dimethylbutyl (meth)acrylate, hexyl (meth)acrylate, 2-ethylhexyl (meth)acrylate, octyl (meth)acrylate, ethyl (meth)acrylate, n-butyl (meth)acrylate, 2-methylbutyl (meth)acrylate, pentyl (meth)acrylate, heptyl (meth)acrylate, nonyl (meth)acrylate, 3-ethoxypropyl (meth)acrylate, 3-ethoxybutyl (meth)acrylate, dimethylaminoethyl (meth)acrylate, 2-hydroxyethyl (meth)acrylate, 2-hydroxybutyl (meth)acrylate, ethyl-α-(hydroxymethyl) (meth)acrylate, dimethylaminoethyl (meth)acrylate, hydroxyethyl (meth)acrylate, hydroxypropyl (meth)acrylate, phenyl (meth)acrylate, benzyl (meth)acrylate, phenylethyl (meth)acrylate, diethylene glycol (meth)acrylate, triethylene glycol (meth)acrylate, polyethylene glycol (meth)acrylate, glycerin (meth)acrylate, bisphenol A (meth)acrylate, dimethyl maleate, diethyl maleate, and vinyl acetate. These can be used alone or in combination of two or more. Note that the term “(meth)acrylate” refers to acrylate or methacrylate.

As the radical polymer, a polymer having a linear structure formed by radical polymerization of the monomers, a polymer having a graft structure, or a polymer having a crosslinked structure can be used. In each polymer, the monomer sequence is not particularly limited, and a polymer having a random sequence or block sequence can be used.

The radical polymer to be used preferably has a weight average molecular weight in a range of 2,000 to 20,000, and more preferably in a range of 5,000 to 20,000. Furthermore, when the weight average molecular weight is in a range of 7,000 to 15,000, aggregation or sedimentation of the pigment (A) is unlikely to occur, the storage stability of the water-based pigment dispersion improves, and ink ejection stability further improves, which is particularly preferable.

Note that the weight average molecular weight is a value measured by GPC (gel permeation chromatography), in terms of a value converted to the molecular weight of polystyrene used as a reference material.

As the radical polymer, one in which acid groups in the radical polymer are partially or completely neutralized by a basic compound (neutralized material) is preferably used from the viewpoint of further improving the storage stability of the water-based pigment dispersion.

Examples of the basic compound that can be used include a hydroxide of an alkali metal such as potassium or sodium; a carbonate of an alkali metal such as potassium or sodium; a carbonate of an alkaline-earth metal such as calcium or barium; inorganic basic compounds such as ammonium hydroxide, and organic basic compounds, e.g., amino alcohols such as triethanolamine, N,N-dimethanolamine, N-aminoethylethanolamine, dimethylethanolamine, and N—N-butyldiethanolamine, morpholines such as morpholine, N-methylmorpholine, and N-ethylmorpholine, and piperazines such as N-(2-hydroxyethyl)piperazine and piperazine hexahydrate. Among them, preferably, an alkali metal hydroxide, such as potassium hydroxide, sodium hydroxide, or lithium hydroxide, is used as the basic compound from the viewpoint of contributing to a decrease in the viscosity of the water-based pigment dispersion and further improving the storage stability and ejection stability of the ink for inkjet recording, and particularly preferably, potassium hydroxide is used.

The neutralization ratio of the radical polymer is not particularly limited, but is preferably in a range of 80 to 120% from the viewpoint of suppressing aggregation of the radical polymer. In the present invention, the neutralization ratio refers to a value calculated in accordance with the following formula.

Neutralization ratio (%)=[(Mass (g) of basic compound×56.11×1,000)/[Acid value (mg KOH/g) of radical polymer×Equivalent of basic compound×Mass (g) of radical polymer}]×100

The basic compound can be dissolved or dispersed in advance in a solvent, such as water, before being mixed with the pigment (A) and others.

In the water-based pigment dispersion according to the present invention, the mass ratio between the pigment (A) and the pigment-dispersing resin (B) [the pigment-dispersing resin (B)/the pigment (A)] can be appropriately selected in a range of 0.1 to 0.7. In order to obtain a water-based pigment dispersion having better dispersion stability and storage stability, the mass ratio [the pigment-dispersing resin (B)/the pigment (A)] is preferably adjusted in a range of 0.1 to 0.4.

As the water (C), pure water, such as ion-exchanged water, ultrafiltration water, reverse osmosis water, or distilled water, or ultrapure water can be used. Furthermore, it is suitable to use, as the water (C), water which is sterilized, for example, by ultraviolet irradiation or addition of hydrogen peroxide because, in the case where the water-based pigment dispersion, an ink using the same, or the like is stored for a long time, generation of mold or bacteria can be prevented.

In the water-based pigment dispersion according to the present invention, the components described above are dissolved or dispersed in water. Furthermore, the water-based pigment dispersion according to the present invention preferably contains a water-soluble organic solvent, in addition to the pigment (A), the pigment-dispersing resin (B), and the water (C), from the viewpoint of improving the wettability of the pigment (A) such that the pigment-dispersing resin can be easily adsorbed.

Examples of the water-soluble organic solvent include glycols, such as ethylene glycol, diethylene glycol, triethylene glycol, tetraethylene glycol, propylene glycol, polyethylene glycol, and polypropylene glycol; diols, such as butanediol, pentanediol, hexanediol, and their homologous diols; glycol esters, such as propylene glycol laurate; glycol ethers, such as ethers, including diethylene glycol monoethyl ether, diethylene glycol monobutyl ether, and diethylene glycol monohexyl ether, and cellosolves, including propylene glycol ether, dipropylene glycol ether, and triethylene glycol ether; alcohols, such as methanol, ethanol, isopropyl alcohol, 1-propanol, 2-propanol, 1-butanol, 2-butanol, pentyl alcohol, and their homologous alcohols; sulfolane; lactones, such as γ-butyrolactone; lactams, such as N-(2-hydroxyethyl)pyrrolidone; glycerin and glycerin derivatives, such as polyoxyalkylene adducts of glycerin; and other various solvents known as water-soluble organic solvents. These can be used alone or in combination of two or more.

As the water-soluble organic solvent, among those described above, a glycol or a polyhydric alcohol, such as a diol, having a high boiling point, low volatility, and high surface tension is preferably used because it also serves as a wetting agent and a drying retarder, and a glycol, such as diethylene glycol or triethylene glycol, is more preferably used.

In the water-based pigment dispersion according to the present invention, the mass ratio between the pigment (A) and the water-soluble organic solvent [the water-soluble organic solvent/the pigment (A)] can be appropriately selected in a range of 0.3 to 2.0. In order to obtain a water-based pigment dispersion having better dispersion stability and storage stability, the mass ratio [the water-soluble organic solvent/the pigment (A)] is preferably adjusted in a range of 0.4 to 1.5.

A method for producing a water-based pigment dispersion according to the present invention includes a step of preparing a kneaded material containing a pigment (A) including C.I. Pigment Orange 64 (a) having a primary particle size of 150 nm or less, and a pigment-dispersing resin (B), and a step of mixing the kneaded material obtained in the previous step with water (C).

First, the pigment (A) including C.I. Pigment Orange 64 (a) having a primary particle size of 150 nm or less, the pigment-dispersing resin (B), and, as necessary, the basic compound and the water-soluble organic solvent are supplied into a container and kneaded. The step of obtaining the kneaded material is not particularly limited and can be performed by a known dispersion method. Examples thereof include a media mill dispersion method which uses media, such as a paint shaker, a bead mill, a sand mill, or a ball mill; a media-less dispersion method which uses an ultrasonic homogenizer, a high-pressure homogenizer, a Nanomizer, an Ultimizer, or the like; and a knead-dispersion method which uses a roll mill, a Henschel mixer, a pressure kneader, an intensive mixer, a Banbury mixer, a planetary mixer, or the like. An ultrasonic homogenizer method is preferably employed because of its effectiveness in decreasing the number of coarse particles.

In the case where the ultrasonic homogenizer method is employed, as an ultrasonic dispersion device, among the devices described above, an ultrasonic dispersing machine is preferably used. When the ultrasonic device is used, the energy applied to the pigment (A) from the device is preferably in a range of 3 to 10 W·h/g.

The water-based pigment dispersion obtained by the method described above may be further subjected to dispersion treatment using a dispersing machine. Examples of the dispersing machine include a paint shaker, a bead mill, a roll mill, a sand mill, a ball mill, an attritor, a basket mill, a sand mill, a sand grinder, a DYNO-MILL, a Dispermat, an SC mill, a spike mill, an agitator mill, a juice mixer, a high-pressure homogenizer, an ultrasonic homogenizer, a Nanomizer, a dissolver, a Disper, a high-speed impeller dispersing machine, a kneader, and a planetary mixer.

The dispersed material contained in the water-based pigment dispersion obtained by the method described above preferably has a volume average particle size of 50 to 300 nm, and most preferably 80 to 180 nm from the viewpoint of obtaining a water-based pigment dispersion having excellent dispersion stability and storage stability.

### (Water-Based Ink for Inkjet Recording)

The water-based pigment dispersion can be diluted to a desired concentration and used in various applications, for example, in the coating field for automobiles and building materials, in the printing ink field, such as offset inks, gravure inks, flexographic inks, and silk screen inks, and in the inkjet recording ink field.

In the case where the water-based pigment dispersion according to the present invention is used for an ink for inkjet recording, by mixing the water-based pigment dispersion, a water-soluble solvent, water, a resin binder, such as an acrylic resin or a polyurethane resin, and, as necessary, an additive, such as a drying retarder, a penetrating agent, or a surfactant, an ink for inkjet recording can be obtained. By subjecting the ink for inkjet recording obtained by the method described above to centrifugal separation or filtration treatment during or after production thereof, coarse particles and the like can be removed. As a result, it is possible to obtain an ink for inkjet recording having excellent dispersion stability and storage stability.

### EXAMPLES

The present invention will be described in more detail below with reference to Examples,

### (Preparation of Pigment by Solvent Salt Milling)

100 Parts by mass of a pigment Y (Cromophtal Orange K 2960 (C.I. Pigment Orange 64, manufactured by BASF, primary particle size 200 nm)), 1,000 parts by mass of sodium chloride (water-soluble inorganic salt), and 200 parts by mass of diethylene glycol (water-soluble organic solvent) were charged into a kneader.

The jacket temperature of the kneader was adjusted to 40° C., and then kneading (solvent salt milling) was performed for 6 hours.

Subsequently, the resulting kneaded material was taken out into a corrosion-resistant container, and then 10 L of a 0.5% by mass aqueous hydrochloric acid solution was added thereto, followed by stirring to obtain a composition in which the sodium chloride and the diethylene glycol were dissolved.

Subsequently, the composition was subjected to filtration, and a residue (pigment portion) was collected. In this case, the residue was washed with warm water and ion-exchanged water such that the sodium chloride and the diethylene glycol did not remain in the residue. By drying the collected residue at 90° C. for 32 hours or more, the moisture was completely removed to obtain a dried material. By pulverizing the dried material with a juicer, a pigment X having a primary particle size of 80 nm was obtained.

The primary particle size of the pigments X and Y was measured and calculated by the method described below.

First, a mixture of 1 part by mass of the pigment X and 99 parts by mass of ethanol was placed dropwise on a mesh coated with collodion film, followed by drying, to obtain a measurement sample.

Next, 1,000 random particles of the measurement sample were observed using a scanning transmission electron microscope (STEM, JSM-7500FA, manufactured by JEOL Ltd., acceleration voltage: 30 kv), and the average value thereof was determined as the primary particle size of the pigment X.

Furthermore, a mixture of 1 part by mass of the pigment Y and 99 parts by mass of ethanol was placed dropwise on a mesh coated with collodion film, followed by drying, to obtain a measurement sample.

Next, 1,000 random particles of the measurement sample were observed using a scanning transmission electron microscope (STEM, JSM-7500FA, manufactured by JEOL Ltd., acceleration voltage: 30 kv), and the average value thereof was determined as the primary particle size of the pigment Y.

### (Radical Polymer A)

A radical polymer A is produced by solution polymerization, is in a powder form (diameter: 1 mm or less), and has a monomer composition ratio of styrene/acrylic acid/methacrylic acid/butyl acrylate of 83.00/7.35/9.55/0.10 (mass ratio), a weight average molecular weight of 11,000, an acid value of 120 mg KOH/g, and a glass transition temperature of 120° C.

### (Radical Polymer B)

A radical polymer B is produced by solution polymerization, is in a powder form (diameter: 1 mm or less), and has a monomer composition ratio of styrene/acrylic acid of 87.70/12.30 (mass ratio), a weight average molecular weight of 8,000, an acid value of 90 mg KOH/g, and a glass transition temperature of 103° C.

### (Radical Polymer C)

A radical polymer C is produced by solution polymerization, is in a powder form (diameter: 1 mm or less), and has a monomer composition ratio of styrene/acrylic acid/methacrylic acid/butyl acrylate of 76.92/9.99/12.99/0.10 (mass ratio), a weight average molecular weight of 8,000, an acid value of 150 mg KOH/g, and a glass transition temperature of 121° C.

### (Radical Polymer D)

A radical polymer D is produced by solution polymerization, is in a powder form (diameter: 1 mm or less), and has a monomer composition ratio of styrene/acrylic acid/methacrylic acid/butyl acrylate of 72.00/12.13/15.77/0.10 (mass ratio), a weight average molecular weight of 8,000, an acid value of 180 mg KOH/g, and a glass transition temperature of 113° C.

### (Radical Polymer E)

A radical polymer E is produced by solution polymerization, is in a powder form (diameter: 1 mm or less), and has a monomer composition ratio of styrene/acrylic acid/butyl acrylate of 90.40/9.50/0.10 (mass ratio), a weight average molecular weight of 8,000, an acid value of 70 mg KOH/g, and a glass transition temperature of 98° C.

### (Radical Polymer F)

A radical polymer F is produced by solution polymerization, is in a powder form (diameter: 1 mm or less), and has a monomer composition ratio of styrene/acrylic acid/methacrylic acid/butyl acrylate of 63.70/15.70/20.5/0.1 (mass ratio), a weight average molecular weight of 8,000, an acid value of 230 mg KOH/g, and a glass transition temperature of 125° C.

The weight average molecular weight is a value measured by GPC (gel permeation chromatography), in terms of a value converted to the molecular weight of polystyrene used as a reference material. The measurement was performed using the following device under the following conditions.

Liquid delivery pump: LC-9A
System controller: SLC-6B

### Auto-injector: S1L-6B

### Detector: RID-6A

These are manufactured by Shimadzu Corporation
Data processing software: Sic480II Data Station
(manufactured by System Instruments Co., Ltd.)
Columns: GL-R400 (guard column)+GL-R440+GL-R450+GL-R400M (manufactured by Hitachi Chemical Company, Ltd.)
Elution solvent: tetrahydrofuran (THF)
Elution flow rate: 2 ml/min
Colum temperature: 35° C.

### Example 1 Method for Producing Water-Based Pigment Dispersion

6 Parts by mass of the radical polymer A, 20 parts by mass of the pigment X, 16 parts by mass of triethylene glycol, 2.03 parts by mass of a 34% by mass aqueous potassium hydroxide solution, and 74 parts by mass of ion-exchanged water were placed in a metal beaker, followed by stirring for 10 minutes using a high shear mixer (L5M-A manufactured by SILVERSON) to obtain a mixture.

Next, the mixture was subjected to ultrasonic dispersion for 30 minutes, using an ultrasonic dispersing machine (UP200St manufactured by Hielscher, Inc., maximum output 200 W, frequency 20 KHz) to obtain a kneaded material. In this case, an energy of 5 W-h/g was applied to the C.I. Pigment Orange 64 from the ultrasonic dispersing machine.

The resulting kneaded material was diluted by adding 15 parts by mass of ion-exchanged water, thereby obtaining a water-based pigment dispersion having a Pigment Orange 64 concentration of 15% by mass.

### Example 2

A water-based pigment dispersion was obtained by the same method as that in Example 1 except that 6 parts by mass of the radical polymer B was used instead of 6 parts by mass of the radical polymer A, and the amount of the 34% by mass aqueous potassium hydroxide solution used was changed from 2.03 parts by mass to 1.52 parts by mass. The ratio (R/P) of the mass of the radical polymer B to the mass of the pigment X was 0.3, and the ratio (S/P) of the mass of the water-soluble organic solvent to the mass of the pigment X was 0.80.

### Example 3

A water-based pigment dispersion was obtained by the same method as that in Example 1 except that 6 parts by mass of the radical polymer C was used instead of 6 parts by mass of the radical polymer A, and the amount of the 34% by mass aqueous potassium hydroxide solution used was changed from 2.03 parts by mass to 2.54 parts by mass. The ratio (R/P) of the mass of the radical polymer C to the mass of the pigment X was 0.3, and the ratio (S/P) of the mass of the water-soluble organic solvent to the mass of the pigment X was 0.80.

### Example 4

A water-based pigment dispersion was obtained by the same method as that in Example 1 except that 6 parts by mass of the radical polymer D was used instead of 6 parts by mass of the radical polymer A, and the amount of the 34% by mass aqueous potassium hydroxide solution used was changed from 2.03 parts by mass to 3.05 parts by mass. The ratio (R/P) of the mass of the radical polymer D to the mass of the pigment X was 0.3, and the ratio (S/P) of the mass of the water-soluble organic solvent to the mass of the pigment X was 0.80.

### Example 5

A water-based pigment dispersion was obtained by the same method as that in Example 1 except that 6 parts by mass of the radical polymer E was used instead of 6 parts by mass of the radical polymer A, and the amount of the 34% by mass aqueous potassium hydroxide solution used was changed from 2.03 parts by mass to 1.18 parts by mass. The ratio (R/P) of the mass of the radical polymer E to the mass of the pigment X was 0.3, and the ratio (S/P) of the mass of the water-soluble organic solvent to the mass of the pigment X was 0.80.

### Example 6

A water-based pigment dispersion was obtained by the same method as that in Example 1 except that the amount of the radical polymer A used was changed from 6 parts by mass to 10 parts by mass, the amount of the 34% by mass aqueous potassium hydroxide solution used was changed from 2.03 parts by mass to 3.38 parts by mass, and the amount of ion-exchanged water used was changed from 74 parts by mass to 69 parts by mass. The ratio (R/P) of the mass of the radical polymer A to the mass of the pigment X was 0.5, and the ratio (S/P) of the mass of the water-soluble organic solvent to the mass of the pigment X was 0.80.

### Example 7

A water-based pigment dispersion was obtained by the same method as that in Example 1 except that the amount of triethylene glycol used was changed from 16 parts by mass to 28 parts by mass, and the amount of ion-exchanged water used was changed from 74 parts by mass to 62 parts by mass. The ratio (R/P) of the mass of the radical polymer A to the mass of the pigment X was 0.3, and the ratio (S/P) of the mass of the water-soluble organic solvent to the mass of the pigment X was 1.4.

### Example 8

A water-based pigment dispersion was obtained by the same method as that in Example 1 except that the amount of the radical polymer A used was changed from 6 parts by mass to 2 parts by mass, the amount of the 34% by mass aqueous potassium hydroxide solution used was changed from 2.03 parts by mass to 0.68 parts by mass, and the amount of ion-exchanged water used was changed from 74 parts by mass to 79 parts by mass. The ratio (R/P) of the mass of the radical polymer A to the mass of the pigment X was 0.1, and the ratio (S/P) of the mass of the water-soluble organic solvent to the mass of the pigment X was 0.80.

### Example 9

A water-based pigment dispersion was obtained by the same method as that in Example 1 except that the amount of the radical polymer A used was changed from 6 parts by mass to 14 parts by mass, the amount of the 34% by mass aqueous potassium hydroxide solution used was changed from 2.03 parts by mass to 4.74 parts by mass, and the amount of ion-exchanged water used was changed from 74 parts by mass to 63 parts by mass. The ratio (R/P) of the mass of the radical polymer A to the mass of the pigment X was 0.7, and the ratio (S/P) of the mass of the water-soluble organic solvent to the mass of the pigment X was 0.80.

### Example 10

A water-based pigment dispersion was obtained by the same method as that in Example 1 except that 6 parts by mass of the radical polymer C was used instead of 6 parts by mass of the radical polymer A, the amount of the 34% by mass aqueous potassium hydroxide solution used was changed from 2.03 parts by mass to 2.54 parts by mass, and the amount of triethylene glycol used was changed from 16 parts by mass to 28 parts by mass. The ratio (R/P) of the mass of the radical polymer C to the mass of the pigment X was 0.3, and the ratio (S/P) of the mass of the water-soluble organic solvent to the mass of the pigment X was 1.40.

### Example 11

A water-based pigment dispersion was obtained by the same method as that in Example 1 except that 6 parts by mass of the radical polymer C was used instead of 6 parts by mass of the radical polymer A, the amount of the 34% by mass aqueous potassium hydroxide solution used was changed from 2.03 parts by mass to 2.54 parts by mass, the amount of triethylene glycol used was changed from 16 parts by mass to 8 parts by mass, and the amount of ion-exchanged water used was changed from 74 parts by mass to 81 parts by mass. The ratio (R/P) of the mass of the radical polymer C to the mass of the pigment X was 0.3, and the ratio (S/P) of the mass of the water-soluble organic solvent to the mass of the pigment X was 0.40.

### Example 12

A water-based pigment dispersion was obtained by the same method as that in Example 1 except that the amount of the radical polymer A used was changed from 6 parts by mass to 16 parts by mass, the amount of the 34% by mass aqueous potassium hydroxide solution used was changed from 2.03 parts by mass to 5.41 parts by mass, and the amount of ion-exchanged water used was changed from 74 parts by mass to 60 parts by mass. The ratio (R/P) of the mass of the radical polymer A to the mass of the pigment X was 0.8, and the ratio (S/P) of the mass of the water-soluble organic solvent to the mass of the pigment X was 0.80.

### Example 13

A water-based pigment dispersion was obtained by the same method as that in Example 1 except that the amount of the radical polymer A used was changed from 6 parts by mass to 1 part by mass, the amount of the 34% by mass aqueous potassium hydroxide solution used was changed from 2.03 parts by mass to 0.34 parts by mass, and the amount of ion-exchanged water used was changed from 74 parts by mass to 80 parts by mass. The ratio (R/P) of the mass of the radical polymer A to the mass of the pigment X was 0.05, and the ratio (S/P) of the mass of the water-soluble organic solvent to the mass of the pigment X was 0.80.

### Example 14

A water-based pigment dispersion was obtained by the same method as that in Example 1 except that the amount of triethylene glycol used was changed from 16 parts by mass to 4 parts by mass, and the amount of ion-exchanged water used was changed from 74 parts by mass to 86 parts by mass. The ratio (R/P) of the mass of the radical polymer A to the mass of the pigment X was 0.3, and the ratio (S/P) of the mass of the water-soluble organic solvent to the mass of the pigment X was 0.2.

### Example 15

A water-based pigment dispersion was obtained by the same method as that in Example 1 except that the amount of triethylene glycol used was changed from 16 parts by mass to 34 parts by mass, and the amount of ion-exchanged water used was changed from 74 parts by mass to 56 parts by mass. The ratio (R/P) of the mass of the radical polymer A to the mass of the pigment X was 0.3, and the ratio (S/P) of the mass of the water-soluble organic solvent to the mass of the pigment X was 1.7.

### Comparative Example 1

A water-based pigment dispersion was obtained by the same method as that in Example 1 except that 20 parts by mass of a pigment Y “Cromophtal Orange K 2960” (C.I. Pigment Orange 64, manufactured by BASF, primary particle size 200 nm) which was not subjected to the solvent salt milling treatment was used instead of 20 parts by mass of the pigment X. The ratio (R/P) of the mass of the radical polymer A to the mass of the pigment Y was 0.3, and the ratio (S/P) of the mass of the water-soluble organic solvent to the mass of the pigment Y was 0.80.

### Comparative Example 2

A water-based pigment dispersion was obtained by the same method as that in Example 1 except that 20 parts by mass of a pigment Y “Cromophtal Orange K 2960” (C.I. Pigment Orange 64, manufactured by BASF, primary particle size 200 nm) which was not subjected to the solvent salt milling treatment was used instead of 20 parts by mass of the pigment X, 6 parts by mass of the radical polymer D was used instead of 6 parts by mass of the radical polymer A, and the amount of the 34% by mass aqueous potassium hydroxide solution used was changed from 2.03 parts by mass to 3.05 parts by mass. The ratio (R/P) of the mass of the radical polymer D to the mass of the pigment Y was 0.3, and the ratio (S/P) of the mass of the water-soluble organic solvent to the mass of the pigment Y was 0.80.

### Comparative Example 3

A water-based pigment dispersion was obtained by the same method as that in Example 1 except that 20 parts by mass of the pigment X was used, 6 parts by mass of the radical polymer F was used instead of 6 parts by mass of the radical polymer A, the amount of the 34% by mass aqueous potassium hydroxide solution used was changed from 2.03 parts by mass to 3.89 parts by mass, and the amount of ion-exchanged water used was changed from 74 parts by mass to 72 parts by mass. The ratio (R/P) of the mass of the radical polymer F to the mass of the pigment X was 0.3, and the ratio (S/P) of the mass of the water-soluble organic solvent to the mass of the pigment X was 0.80.

### (Evaluation of Water-Based Pigment Dispersion)

### [Method of Measuring Volume Average Particle Size]

First, each of the water-based pigment dispersions prepared in Examples and Comparative Examples was diluted 2,000 times with ion-exchanged water.

Next, about 4 ml of the diluted water-based pigment dispersion was placed in a cell, and a volume average particle size (MV) was measured, using a Nanotrac particle size distribution analyzer “UPA150” manufactured by MicrotracBEL Corp., by detecting scattered light of laser in an environment of 25° C.

The volume average particle size was measured three times, and a value calculated from an average of the three measured values by taking the first two digits of the average as significant figures was determined as a volume average particle size value (unit: nm). The case where the volume average particle size was 190 nm or less was evaluated as good.

### [Method of Measuring the Number of Coarse Particles]

First, each of the water-based pigment dispersions prepared in Examples and Comparative Examples was diluted 50 times with ion-exchanged water.

Next, using a particle number counting-type particle size distribution analyzer (Accusizer 780 APS) manufactured by Particle Sizing Systems, the number of particles having a diameter of 0.5 μm or more contained in the diluted water-based pigment dispersion was measured three times.

Next, the measured values were each multiplied by the dilution concentration to calculate the numbers of coarse particles. Then, an average of the three numbers of coarse particles calculated by the method described above was determined as the number of coarse particles of each of the water-based pigment dispersions prepared in Examples and Comparative Examples.

### (Test Method for Dispersion Stability of Water-Based Pigment Dispersion)

The dispersion stability of the water-based pigment dispersion was evaluated on the basis of the decrease rate of absorbance.

First, each of the water-based pigment dispersions immediately after preparation in Examples and Comparative Examples was diluted 10,000 times (volume) with ion-exchanged water, and by measuring its absorption spectrum using an ultraviolet and visible spectrophotometer V-660 manufactured by JASCO Corporation, an absorbance W₀ at maximum absorption wavelength was calculated.

Next, a glass test tube containing 30 ml of the water-based pigment dispersion was allowed to stand upright for 2 weeks in an environment of room temperature (25° C.).

The upper portion of the water-based pigment dispersion which had been allowed to stand was collected and diluted 10,000 times (volume), which was used as a sample. By measuring the absorption spectrum of the sample using an ultraviolet and visible spectrophotometer V-660 manufactured by JASCO Corporation, an absorbance W₁ at maximum absorption wavelength was calculated.

Subsequently, a decrease rate of absorbance was calculated using the absorbance W₀ and the absorbance W₁, in accordance with the formula [(absorbance W₀−absorbance W₁)/absorbance W₀]. In the case where the decrease rate was 0% or more and less than 20%, dispersion stability was evaluated to be good “◯”, in the case where the decrease rate was 20% or more and less than 50%, dispersion stability was evaluated to be average “Δ”, and in the case where the decrease rate was 50% or more, dispersion stability was evaluated to be poor “x”.

### (Test Method for Storage Stability of Water-Based Pigment Dispersion)

First, in each of the water-based pigment dispersions immediately after preparation in Examples and Comparative Examples, the number of coarse particles was measured by the same method as that described in the [method of measuring the number of coarse particles].

Next, each of the water-based pigment dispersions obtained in Examples and Comparative Examples was placed and sealed in a polypropylene container and stored at 60° C. for 4 weeks, and then the number of coarse particles was measured by the same method as that in the [method of measuring the number of coarse particles].

Subsequently, a rate of change in number of coarse particles was calculated on the basis of the number of coarse particles in the water-based pigment dispersion immediately after preparation, the number of coarse particles in the water-based pigment dispersion after storage, and the formula: rate of change (%)=[(number of coarse particles in water-based pigment dispersion after storage−number of coarse particles in water-based pigment dispersion immediately after preparation)/number of coarse particles in water-based pigment dispersion immediately after preparation]×100. When the rate of change was 10% or less, storage stability was evaluated to be good.

TABLE 1

| | Example 1 | Example 2 | Example 3 | Example 4 | Example 5 |
|---|---|---|---|---|---|
| Pigment | X | X | X | X | X |
| Primary particle | 80 | 80 | 80 | 80 | 80 |
| size of pigment (nm) | | | | | |
| Radical polymer | A | B | C | D | E |
| Acid value of | 120 | 90 | 150 | 180 | 70 |
| radical polymer | | | | | |
| Mass ratio [radical | 0.3 | 0.3 | 0.3 | 0.3 | 0.3 |
| polymer/pigment] | | | | | |
| Water-soluble | Triethylene | Triethylene | Triethylene | Triethylene | Triethylene |
| organic solvent | glycol | glycol | glycol | glycol | glycol |
| Mass ratio [water- | 0.8 | 0.8 | 0.8 | 0.8 | 0.8 |
| soluble organic | | | | | |
| solvent/pigment] | | | | | |
| Volume average | 130 | 135 | 160 | 210 | 135 |
| particle size (nm) | | | | | |
| Number of coarse | 5,000 | 6,000 | 7,000 | 13,000 | 7,000 |
| particles (×10⁶ | | | | | |
| particles/ml) | | | | | |
| Dispersibility | ◯ | ◯ | ◯ | ◯ | ◯ |
| Storage stability | 4.6% | 5.2% | 4.9% | 6.3% | 4.8% |
| (rate of change | | | | | |
| in number of | | | | | |
| coarse particles) | | | | | |

TABLE 2

| | Example 6 | Example 7 | Example 8 | Example 9 | Example 10 |
|---|---|---|---|---|---|
| Pigment | X | X | X | X | X |
| Primary particle | 80 | 80 | 80 | 80 | 80 |
| size of pigment (nm) | | | | | |
| Radical polymer | A | A | A | A | C |
| Acid value of | 120 | 120 | 120 | 120 | 150 |
| radical polymer | | | | | |
| Mass ratio [radical | 0.5 | 0.3 | 0.1 | 0.7 | 0.3 |
| polymer/pigment] | | | | | |
| Water-soluble | Triethylene | Triethylene | Triethylene | Triethylene | Triethylene |
| organic solvent | glycol | glycol | glycol | glycol | glycol |
| Mass ratio [water- | 0.8 | 1.4 | 0.8 | 0.8 | 1.4 |
| soluble organic | | | | | |
| solvent/pigment] | | | | | |
| Volume average | 145 | 145 | 150 | 150 | 165 |
| particle size (nm) | | | | | |
| Number of coarse | 5,000 | 6,000 | 11,000 | 8,000 | 8,000 |
| particles (×10⁶ | | | | | |
| particles/ml) | | | | | |
| Dispersibility | ◯ | ◯ | ◯ | ◯ | ◯ |
| Storage stability | 5.6% | 5.1% | 7.8% | 6.8% | 5.3% |
| (rate of change | | | | | |
| in number of | | | | | |
| coarse particles) | | | | | |

TABLE 3

| | Example 10 | Example 11 | Example 12 | Example 13 | Example 14 | Example 15 |
|---|---|---|---|---|---|---|
| Pigment | X | X | X | X | X | X |
| Primary particle | 80 | 80 | 80 | 80 | 80 | 80 |
| size of pigment (nm) | | | | | | |
| Radical polymer | C | C | A | A | A | A |
| Acid value of | 150 | 150 | 120 | 120 | 120 | 120 |
| radical polymer | | | | | | |
| Mass ratio [radical | 0.3 | 0.3 | 0.8 | 0.05 | 0.3 | 0.3 |
| polymer/pigment] | | | | | | |
| Water-soluble | Triethylene | Triethylene | Triethylene | Triethylene | Triethylene | Triethylene |
| organic solvent | glycol | glycol | glycol | glycol | glycol | glycol |
| Mass ratio [water- | 1.4 | 0.4 | 0.8 | 0.8 | 0.2 | 1.7 |
| soluble organic | | | | | | |
| solvent/pigment] | | | | | | |
| Volume average | 165 | 170 | 165 | 170 | 180 | 160 |
| particle size (nm) | | | | | | |
| Number of coarse | 8,000 | 10,000 | 20,000 | 50,000 | 40,000 | 20,000 |
| particles (×10⁶ | | | | | | |
| particles/ml) | | | | | | |
| Dispersibility | ◯ | ◯ | Δ | Δ | Δ | Δ |
| Storage stability | 5.3% | 5.8% | 10.2% | 17.3% | 16.4% | 11.8% |
| (rate of change | | | | | | |
| in number of | | | | | | |
| coarse particles) | | | | | | |

TABLE 4

| | Comparative | Comparative | Comparative |
|---|---|---|---|
| | Example 1 | Example 2 | Example 3 |
| Pigment | Y | Y | X |
| Primary particle | 200 | 200 | 80 |
| size of pigment (nm) | | | |
| Radical polymer | A | D | F |
| Acid value of | 120 | 180 | 230 |
| radical polymer | | | |
| Mass ratio [radical | 0.3 | 0.3 | 0.3 |
| polymer/pigment] | | | |
| Water-soluble | Triethylene | Triethylene | Triethylene |
| organic solvent | glycol | glycol | glycol |
| Mass ratio [water- | 0.8 | 0.8 | 0.8 |
| soluble organic | | | |
| solvent/pigment] | | | |
| Volume average | 300 | 290 | 250 |
| particle size (nm) | | | |
| Number of coarse | 200,000 | 300,000 | 70,000 |
| particles (×10⁶ | | | |
| particles/ml) | | | |
| Dispersibility | x | x | x |
| Storage stability | 24.5% | 32.8% | 18.9% |
| (rate of change | | | |
| in number of | | | |
| coarse particles) | | | |

What is claimed is:

1. A water-based pigment dispersion comprising:
a pigment (A) including C.I. Pigment Orange 64 (a) having a primary particle size of 150 nm or less;
a pigment-dispersing resin (B) containing a radical polymer having an acid value of 50 to 200 mg KOH/g; and
water (C).

2. The water-based pigment dispersion according to claim 1, wherein the pigment-dispersing resin (B) is a radical polymer having a structural unit derived from styrene, and the mass ratio of the structural unit derived from styrene to the total amount of the radical polymer is 50% by mass or more.

3. The water-based pigment dispersion according to claim 1, wherein the mass ratio between the pigment (A) and the pigment-dispersing resin (B) [the pigment-dispersing resin (B)/the pigment (A)] is in a range of 0.1 to 0.7.

4. The water-based pigment dispersion according to claim 1, further comprising a water-soluble organic solvent, wherein the mass ratio between the pigment (A) and the water-soluble organic solvent [the water-soluble organic solvent/the pigment (A)] is in a range of 0.4 to 1.5.

5. A method for producing a water-based pigment dispersion comprising:
a step [1] of producing C.I. Pigment Orange 64 (a) having a primary particle size of 150 nm or less by subjecting C.I. Pigment Orange 64 having a primary particle size of more than 150 nm to salt milling treatment; and
a step [2] of dispersing a pigment (A) including the C.I. Pigment Orange 64 (a) having a primary particle size of 150 nm or less obtained in the step [1] and a pigment-dispersing resin (B) in water (C) by using an ultrasonic dispersing machine.
